(19) United States
(12) Patent Application Publication
(10) Pub. No.: US 2019/0066522 A1
(43) Pub. Date: Feb. 28, 2019

(54) Controlling Landings of an Aerial Robotic Vehicle Using Three-Dimensional Terrain Maps Generated Using Visual-Inertial Odometry

(71) Applicant: QUALCOMM Incorporated, San Diego, CA (US)

(72) Inventors: Charles Wheeler SWEET III, San Diego, CA (US); Daniel Warren MELLINGER, Philadelphia, PA (US); John Anthony DOUGHERTY, Philadelphia, PA (US)

(21) Appl. No.: 15/683,240

(22) Filed: Aug. 22, 2017

(51) Int. Cl. G08G 5/00; G01S 13/91; G05D 1/06

(52) U.S. Cl. CPC G08G 5/0086; G05D 1/0676; G01S 13/913; G08G 5/0069

(57) ABSTRACT

Various embodiments include methods that may be implemented in a processor or processing device of an aerial robotic vehicle for generating three-dimensional terrain map based on the plurality of altitude above ground level values generated using visual-inertial odometry, and using such terrain maps to control the altitude of the aerial robotic vehicle. Some methods may include using the generated three-dimensional terrain map during landing. Such embodiment may further include refining the three-dimensional terrain map using visual-inertial odometry as the vehicle approaches the ground and using the refined terrain maps during landing. Some embodiments may include using the three-dimensional terrain map to select a landing site for the vehicle.

### BACKGROUND

Robotic vehicles, such as unmanned aerial vehicles (“UAV” or drones), may be controlled to perform a variety of complex maneuvers, including landings. Determining where to land and how to land may be difficult depending on surface features of a given terrain. For example, it may be more difficult for an aerial robotic vehicle to land on undulating and/or rocky terrain as opposed to terrain that is relatively flat and/or smooth.

In order to locate a suitable landing area, some robotic vehicles may be equipped with cameras or other sensors to detect landing targets manually-placed at a destination. For example, a landing target may be a unique marking or beacon for identifying a suitable landing area that is detectable by a camera or sensor. However, there may be instances when an aerial robotic vehicle may need to land at an unmarked location. For example, in an emergency situation (e.g., low battery supply), an aerial robotic vehicle may have to land on terrain without the aid of landing targets.

As the robotic vehicle approaches the landing target, the vehicle may generate distance estimates between the vehicle and the target to facilitate a soft landing. The distance estimates may be determined using sonar sensors and barometers. However, the use of sonar sensors and barometers may increase the complexity of the robotic vehicle and/or consume significant amounts of power or other resources.

### SUMMARY

Various embodiments include methods that may be implemented within a processing device of an aerial robotic vehicle for using three-dimensional maps generated by the processing device using visual-inertial odometry to determine altitude above ground level. Various embodiments may include determining a plurality of altitude above ground level values of the aerial robotic vehicle navigating above a terrain using visual-inertial odometry, generating a three-dimensional terrain map based on the plurality of altitude above ground level values, and using the generated terrain map to control altitude of the aerial robotic vehicle.

In some embodiments, using the generated terrain map to control altitude of the aerial robotic vehicle may include using the generated terrain map to control a landing of the aerial robotic vehicle. In some embodiments, using the generated terrain map to control the landing of the aerial robotic vehicle may include analyzing the terrain map to determine surface features of the terrain, and selecting a landing area on the terrain having one or more surface features suitable for landing the aerial robotic vehicle based on the analysis of the terrain map. In some embodiments, the one or more surface features suitable for landing the aerial robotic vehicle may include a desired surface type, size, texture, incline, contour, accessibility, or any combination thereof. In some embodiments, selecting a landing area on the terrain further may include using deep learning classification techniques by the processor to classify surface features within the generated terrain map, and selecting the landing area from among surface features classified as potential landing areas. In some embodiments, using the generated terrain map to control the landing of the aerial robotic vehicle further may include determining a trajectory for landing the aerial robotic vehicle based on a surface feature of the selected landing area. In some situations, the surface feature of the selected landing area may be a slope, in which case determining the trajectory for landing the aerial robotic vehicle based on the surface feature of the selected landing area may include determining a slope angle of the selected landing area, and determining the trajectory for landing the aerial robotic vehicle based on the determined slope angle.

Some embodiments may include determining a position of the aerial robotic vehicle while descending towards a landing area, using the determined position of the aerial robotic vehicle and the terrain map to determine whether the aerial robotic vehicle is in close proximity to the landing area, and reducing a speed of the aerial robotic vehicle to facilitate a soft landing in response to determining that the aerial robotic vehicle is in close proximity to the landing area.

Some embodiments may include determining a plurality of updated altitude above ground level values using visual-inertial odometry as the aerial robotic vehicle descends towards a landing area, updating the terrain map based on the plurality of updated altitude above ground level values, and using the updated terrain map to control the landing of the aerial robotic vehicle.

Further embodiments include an aerial robotic vehicle including a processing device configured to perform operations of any of the methods summarized above. In some embodiments, the aerial robotic vehicle may be an autonomous aerial robotic vehicle. Further embodiments include a processing device for use in an autonomous aerial robotic vehicle and configured to perform operations of any of the methods summarized above. Further embodiments include an autonomous aerial robotic vehicle having means for performing functions of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIGS. 1A and 1B illustrate front elevation and plan views, respectively, of an aerial robotic vehicle equipped with a camera suitable for use in some embodiments.

FIG. 2 is a component block diagram illustrating a control unit of an aerial robotic vehicle suitable for use in some embodiments.

FIG. 3 is a component block diagram illustrating a processing device suitable for use in some embodiments.

FIG. 4 illustrates a method of controlling an aerial robotic vehicle to land using three-dimensional terrain maps generated using visual-inertial odometry to determine altitude above ground level (AGL) values according to some embodiments.

FIG. 5 is a schematic diagram of an aerial robotic vehicle determining altitude AGL values while navigating above a given terrain according to some embodiments.

FIG. 6 illustrates a topological 3-D terrain map generated using visual-inertial odometry according to some embodiments.

FIG. 7 illustrates a method of controlling selection of a landing area on the terrain using altitude AGL values obtained from a 3-D terrain map generated using visual-inertial odometry according to some embodiments.

FIG. 8 illustrates a method of controlling a landing trajectory of an aerial robotic vehicle using altitude AGL values obtained from a 3-D terrain map generated using visual-inertial odometry according to some embodiments.

FIG. 9 illustrates a controlled landing of an aerial robotic vehicle on a sloped landing area using altitude AGL values obtained from a 3-D terrain map generated using visual-inertial odometry according to some embodiments.

FIG. 10 illustrates a method 1000 of controlling the speed of an aerial robotic vehicle to facilitate a soft or controlled landing of the aerial robotic vehicle using 3-D terrain maps generated based on visual-inertial odometry according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments are disclosed for controlling an aerial robotic vehicle to land using altitude above ground level (AGL) values obtained from three-dimensional (3-D) terrain maps generated by a processing device using visual-inertial odometry. Visual-inertial odometry is a known technique in computer vision for determining the position and orientation of an aerial robotic vehicle in an environment by combining visual information extracted from sequences of images of the environment with inertial data of vehicle movements during image capture. Typically, visual-inertial odometry is used for detecting the proximity of obstacles relative to vehicles (e.g., an aerial robotic vehicle) for the purpose of collision avoidance. In various embodiments, visual-inertial odometry is used by a processor of an aerial robotic vehicle to generate a 3-D terrain map that is then used to determine the AGL altitude of the aerial robotic vehicle relative to various surface features. The AGL altitude information may then be used for navigating the aerial robotic vehicle close to the ground, such as during landings or takeoffs.

As used herein, the terms “aerial robotic vehicle” and “drone” refer to one of various types of aerial vehicles including an onboard processing device configured to provide some autonomous or semi-autonomous capabilities. Examples of aerial robotic vehicles include but are not limited to rotorcraft and winged aircraft. In some embodiments, the aerial robotic vehicle may be manned. In other embodiments, the aerial robotic vehicle may be unmanned. In embodiments in which the aerial robotic vehicle is autonomous, the robotic vehicle may include an onboard processing device configured to control maneuvers and/or navigate the robotic vehicle without remote operating instructions (i.e., autonomously), such as from a human operator (e.g., via a remote computing device). In embodiments in which the aerial robotic vehicle is semi-autonomous, the aerial robotic vehicle may include an onboard processing device configured to receive some information or instructions, such as from a human operator (e.g., via a remote computing device), and autonomously maneuver and/or navigate the aerial robotic vehicle consistent with the received information or instructions. Aerial robotic vehicles that are rotorcraft (also referred to as a multirotor or multicopter) may include a plurality of propulsion units (e.g., rotors/propellers) that provide propulsion and/or lifting forces for the robotic vehicle. Non-limiting examples of rotorcraft include tricopters (three rotors), quadcopters (four rotors), hexacopters (six rotors), and octocopters (eight rotors). However, a rotorcraft may include any number of rotors.

The term “processing device” is used herein to refer to an electronic device equipped with at least a processor. Examples of processing devices may include flight control and/or mission management processors that are onboard the aerial robotic device. In various embodiments, processing devices may be configured with memory and/or storage as well as wireless communication capabilities, such as network transceiver(s) and antenna(s) configured to establish a wide area network (WAN) connection (e.g., a cellular network connection, etc.) and/or a local area network (LAN) connection (e.g., a wireless connection to the Internet via a Wi-Fi® router, etc.).

The term “computing device” is used herein to refer to remote computing devices communicating with the aerial robotic vehicle configured to perform operations of the various embodiments. Remote computing devices may include wireless communication devices (e.g., cellular telephones, wearable devices, smart-phones, web-pads, tablet computers, Internet enabled cellular telephones, Wi-Fi® enabled electronic devices, personal data assistants (PDA's), laptop computers, etc.), personal computers, and servers. In various embodiments, computing devices may be configured with memory and/or storage as well as wireless communication capabilities, such as network transceiver(s) and antenna(s) configured to establish a wide area network (WAN) connection (e.g., a cellular network connection, etc.) and/or a local area network (LAN) connection (e.g., a wireless connection to the Internet via a Wi-Fi® router, etc.).

In various embodiments, terrain maps generated using a visual-inertial odometry system used in various embodiments differ from typical topological maps that are 3-D terrain maps of surface features based on altitude above sea level measurements. For example, an aerial robotic vehicle using a conventional topological map based on above sea level measurements of altitude must determine its own altitude above sea level and compare that altitude to the map data to determine the AGL. In contrast, various embodiments include generating a 3-D terrain map using visual-inertial odometry while operating the aerial robotic vehicle and using the generated map to determine AGL values of the aerial robotic vehicle as the vehicle moves in any direction, and particularly when determining a landing site and while approaching the ground during landing.

In some embodiments, 3-D terrain maps generated by a processing device of an aerial robotic vehicle during flight using visual-inertial odometry may be used by the processing device to determined AGL values to navigate the aerial robotic vehicle during landing. In some embodiments, a 3-D terrain map generated during flight by a visual-inertial odometry system of an aerial robotic vehicle may be used by a processing device of the aerial robotic vehicle to select a landing area on the terrain, determine a flight path to the selected landing area, and/or control the speed of the aerial robotic vehicle to facilitate achieving a soft landing on the selected landing area.

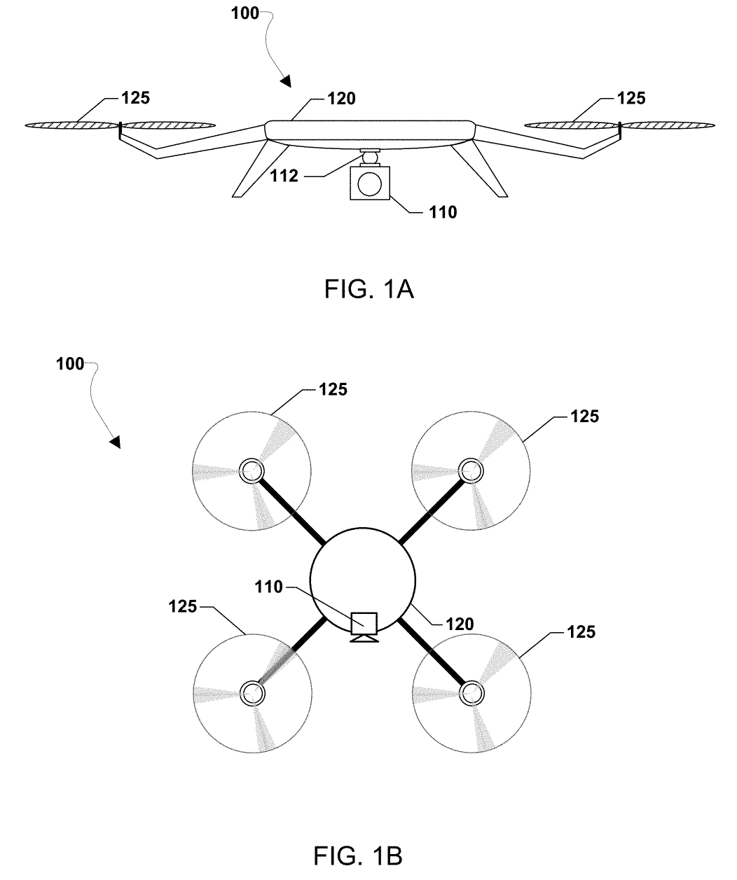

FIGS. 1A and 1B illustrate front elevation and plan views, respectively, of an aerial robotic vehicle 100 equipped with camera 110 suitable for use in some embodiments. With reference to FIGS. 1A and 1B, in some embodiments, the camera 110 may be a monoscopic camera that is capable of capturing images within a limited field of view. The camera 110 may be attached to a gimbal 112 that is attached to a main housing or frame 120 of the aerial robotic vehicle 100. In some embodiments, the camera 110 and the gimbal 112 may be integrated into the main housing 120 of the aerial robotic vehicle 100, such that the camera 110 is exposed through an opening in the main housing 210. The camera 110 may be configured to point in a downward-facing direction for the purpose of capturing images of the terrain beneath the aerial robotic vehicle 100.

The aerial robotic vehicle 100 may include an onboard processing device within the main housing 120 that is configured to fly and/or operate the aerial robotic vehicle 100 without remote operating instructions (i.e., autonomously), and/or with some remote operating instructions or updates to instructions stored in a memory, such as from a human operator or remote computing device (i.e., semi-autonomously).

The aerial robotic vehicle 100 may be propelled for flight in any of a number of known ways. For example, two or more propulsion units, each including one or more rotors 125, may provide propulsion or lifting forces for the aerial robotic vehicle 100 and any payload carried by the aerial robotic vehicle 100. Although the aerial robotic vehicle 100 is illustrated as a quad copter with four rotors, an aerial robotic vehicle 100 may include more or fewer than four rotors 125. In some embodiments, the aerial robotic vehicle 100 may include wheels, tank-treads, or other non-aerial movement mechanisms to enable movement on the ground, on or in water, and combinations thereof. The aerial robotic vehicle 100 may be powered by one or more types of power source, such as electrical, chemical, electro-chemical, or other power reserve, which may power the propulsion units, the onboard processing device, and/or other onboard components. For ease of description and illustration, some detailed aspects of the aerial robotic vehicle 100 are omitted, such as wiring, frame structure, power source, landing columns/gear, or other features that would be known to one of skill in the art.

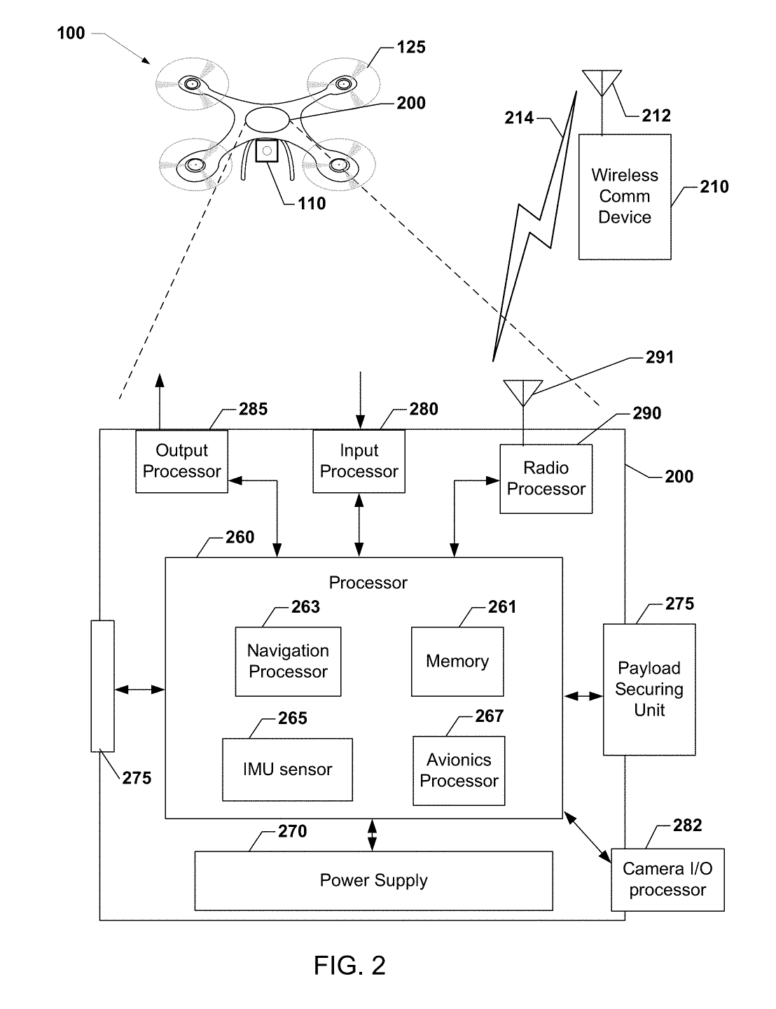

FIG. 2 is a component block diagram illustrating a control unit 200 of an aerial robotic vehicle 100 suitable for use in some embodiments. With reference to FIGS. 1A-2, the control unit 200 may be configured to implement methods of generating a three-dimensional (3-D) topological terrain map and controlling a landing of the aerial robotic vehicle 100 using the generated terrain map. The control unit 200 may include various circuits and devices used to power and control the operation of the aerial robotic vehicle 100. The control unit 200 may include a processor 260, a power supply 270, payload-securing units 275, an input processor 280, a camera input/output (I/O) processor 282, an output processor 285, and a radio processor 290. The camera I/O processor 282 may be coupled to a monoscopic camera 110.

In some embodiments, the avionics processor 267 coupled to the processor 260 and/or the navigation unit 263 may be configured to provide travel control-related information such as attitude, airspeed, heading and similar information that the navigation processor 263 may use for navigation purposes, such as dead reckoning between GNSS position updates. The avionics processor 267 may include or receive data from an inertial measurement unit (IMU) sensors 265 that provides data regarding the orientation and accelerations of the aerial robotic vehicle 100 that may be used in navigation and positioning calculations. For example, in some embodiments, the IMU sensor 265 may include one or more of a gyroscope and an accelerometer.

In some embodiments, the processor 260 may be dedicated hardware specifically adapted to implement methods of generating a 3-D topological terrain map and controlling a landing of the aerial robotic vehicle 100 using the generated terrain map according to some embodiments. In some embodiments, the processor 260 may be a programmable processing unit programmed with processor-executable instructions to perform operations of the various embodiments. The processor 260 may also control other operations of the aerial robotic vehicle, such as navigation, collision avoidance, data processing of sensor output, etc. In some embodiments, the processor 260 may be a programmable microprocessor, microcomputer or multiple processor chip or chips that can be configured by software instructions to perform a variety of functions of the aerial robotic vehicle. In some embodiments, the processor 260 may be a combination of dedicated hardware and a programmable processing unit.

In some embodiments, the processor 260 may be coupled to the camera I/O processor 282 to receive images or data output from the camera or other onboard camera system 110. In some embodiments, the processor 260 may be configured to process, manipulate, store, and/or retransmit the camera output received via the camera I/O processor 282 for a variety of applications, including but not limited to generating a three-dimensional (3-D) topological terrain maps using visual-inertial odometry according to some embodiments in addition to image/video recording, package delivery, collision avoidance, and path planning.

In some embodiments, the processor 260 may include or be coupled to memory 261, a navigation processor 263, an IMU sensor 265, and/or an avionics processor 267. In some embodiments, the navigation processor 263 may include a global navigation satellite system (GNSS) receiver (e.g., one or more global positioning system (GPS) receivers) enabling the aerial robotic vehicle 100 to navigate using GNSS signals. Alternatively or additionally, the navigation processor 263 may be equipped with radio navigation receivers for receiving navigation beacons or other signals from radio nodes, such as navigation beacons (e.g., very high frequency (VHF) omni directional range (VOR) beacons), Wi-Fi® access points, cellular network sites, radio station, remote computing devices, other UAVs, etc. In some embodiments, the processor 260 and/or the navigation processor 263 may be configured to communicate with a server or other wireless communication device 210 through a wireless connection (e.g., a cellular data network) to receive data useful in navigation, provide real-time position reports, and assess data.

In some embodiments, the processor 260 may receive data from the navigation processor 263 and use such data in order to determine the present position and orientation of the aerial robotic vehicle 100, as well as an appropriate course towards a destination or intermediate sites. In some embodiments, the avionics processor 267 coupled to the processor 260 and/or the navigation unit 263 may be configured to provide travel control-related information such as attitude, airspeed, heading and similar information that the navigation processor 263 may use for navigation purposes, such as dead reckoning between GNSS position updates. In some embodiments, the avionics processor 267 may include or receive data from the IMU sensor 265 that provides data regarding the orientation and accelerations of the aerial robotic vehicle 100 that may be used to generate a three-dimensional (3-D) topological terrain map using visual-inertial odometry according to some embodiments in addition to flight control calculations.

In some embodiments, the control unit 200 may be equipped with the input processor 280 and an output processor 285. For example, in some embodiments, the input processor 280 may receive commands or data from various external sources and route such commands or data to the processor 260 to configure and/or control one or more operations of the aerial robotic vehicle 100. In some embodiments, the processor 260 may be coupled to the output processor 285 to output control signals for managing the motors that drive the rotors 125 and other components of the aerial robotic vehicle 100. For example, the processor 260 may control the speed and/or direction of the individual motors of the rotors 125 to enable the aerial robotic vehicle 100 to perform various rotational maneuvers, such as pitch, roll, and yaw.

In some embodiment, the radio processor 290 may be configured to receive navigation signals, such as signals from aviation navigation facilities, etc., and provide such signals to the processor 260 and/or the navigation processor 263 to assist in vehicle navigation. In various embodiments, the navigation processor 263 may use signals received from recognizable radio frequency (RF) emitters (e.g., AM/FM radio stations, Wi-Fi® access points, and cellular network base stations) on the ground. The locations, unique identifiers, signal strengths, frequencies, and other characteristic information of such RF emitters may be stored in a database and used to determine position (e.g., via triangulation and/or trilateration) when RF signals are received by the radio processor 290. Such a database of RF emitters may be stored in the memory 261 of the aerial robotic vehicle 100, in a ground-based server in communication with the processor 260 via a wireless communication link, or in a combination of the memory 261 and a ground-based server (not shown).

In some embodiment, the processor 260 may use the radio processor 290 to conduct wireless communications with a variety of wireless communication devices 210, such as a beacon, server, smailphone, tablet, or other computing device with which the aerial robotic vehicle 100 may be in communication. A bi-directional wireless communication link (e.g., wireless signals 214) may be established between a transmit/receive antenna 291 of the radio processor 290 and a transmit/receive antenna 212 of the wireless communication device 210. In an example, the wireless communication device 210 may be a cellular network base station or cell tower. The radio processor 290 may be configured to support multiple connections with different wireless communication devices (e.g., wireless communication device 210) having different radio access technologies.

In some embodiments, the processor 260 may be coupled to one or more payload-securing units 275. The payload-securing units 275 may include an actuator motor that drives a gripping and release mechanism and related controls that are responsive to the control unit 200 to grip and release a payload package in response to commands from the control unit 200.

In some embodiments, the power supply 270 may include one or more batteries that may provide power to various components, including the processor 260, the payload-securing units 275, the input processor 280, the camera I/O processor 282, the output processor 285, and the radio processor 290. In addition, the power supply 270 may include energy storage components, such as rechargeable batteries. In this way, the processor 260 may be configured with processor-executable instructions to control the charging of the power supply 270, such as by executing a charging control algorithm using a charge control circuit. Alternatively or additionally, the power supply 270 may be configured to manage its own charging.

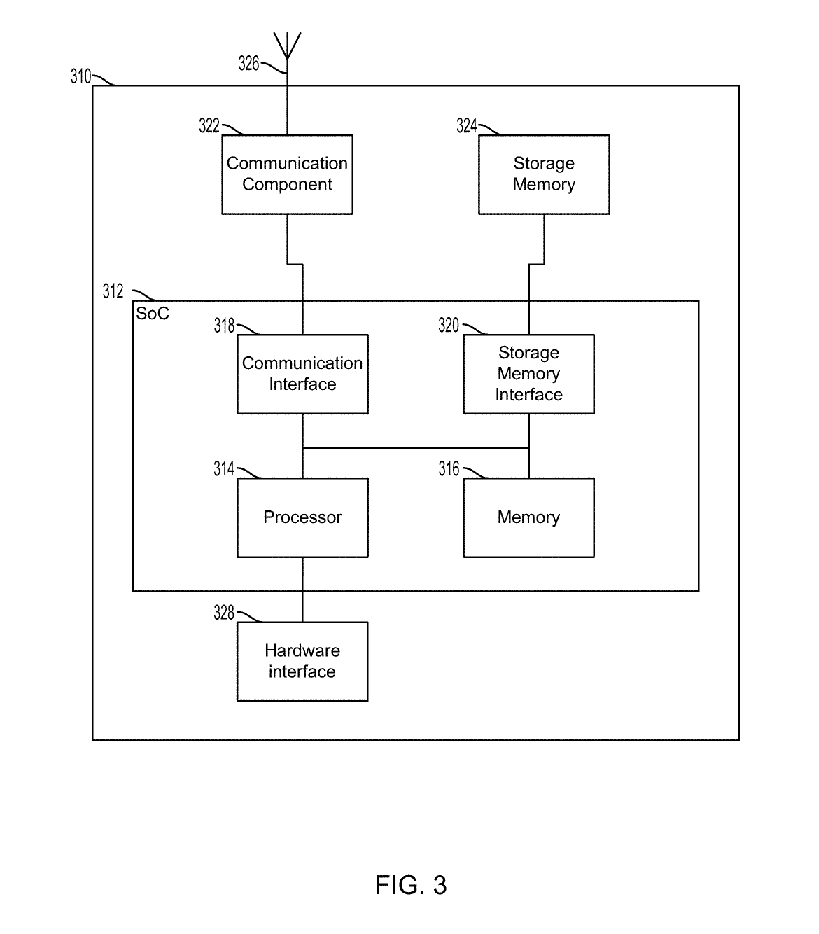

While the various components of the control unit 200 are illustrated in FIG. 2 as separate components, some or all of the components (e.g., the processor 260, the output processor 285, the radio processor 290, and other units) may be integrated together in a single device or processor system, such as a system-on-chip. For example, various embodiments may be implemented within a processing device 310 configured to be used in an aerial robotic vehicle (e.g., 100). A processing device may be configured as or including a system-on-chip (SoC) 312, an example of which is illustrated FIG. 3. With reference to FIGS. 1-3, the SoC 312 may include (but is not limited to) a processor 314, a memory 316, a communication interface 318, and a storage memory interface 320. The processing device 310 or the SoC 312 may further include a communication component 322, such as a wired or wireless modem, a storage memory 324, an antenna 326 for establishing a wireless communication link, and/or the like. The processing device 310 or the SoC 312 may further include a hardware interface 328 configured to enable the processor 314 to communicate with and control various components of an aerial robotic vehicle. The processor 314 may include any of a variety of processing devices, for example any number of processor cores.

The term “system-on-chip” (SoC) is used herein to refer to a set of interconnected electronic circuits typically, but not exclusively, including one or more processors (e.g., 314), a memory (e.g., 316), and a communication interface (e.g., 318). The SoC 312 may include a variety of different types of processors 314 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 312 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 312 may include one or more processors 314. The processing device 310 may include more than one SoC 312, thereby increasing the number of processors 314 and processor cores. The processing device 310 may also include processors 314 that are not associated with an SoC 312 (i.e., external to the SoC 312). Individual processors 314 may be multicore processors. The processors 314 may each be configured for specific purposes that may be the same as or different from other processors of the processing device 310 or SoC 312. One or more of the processors 314 and processor cores of the same or different configurations may be grouped together. A group of processors 314 or processor cores may be referred to as a multi-processor cluster.

The memory 316 of the SoC 312 may be a volatile or non-volatile memory configured for storing data and processor-executable instructions for access by the processor 314. The processing device 310 and/or SoC 312 may include one or more memories 316 configured for various purposes. One or more memories 316 may include volatile memories such as random access memory (RAM) or main memory, or cache memory.

Some or all of the components of the processing device 310 and the SoC 312 may be arranged differently and/or combined while still serving the functions of the various aspects. The processing device 310 and the SoC 312 may not be limited to one of each of the components, and multiple instances of each component may be included in various configurations of the processing device 310.

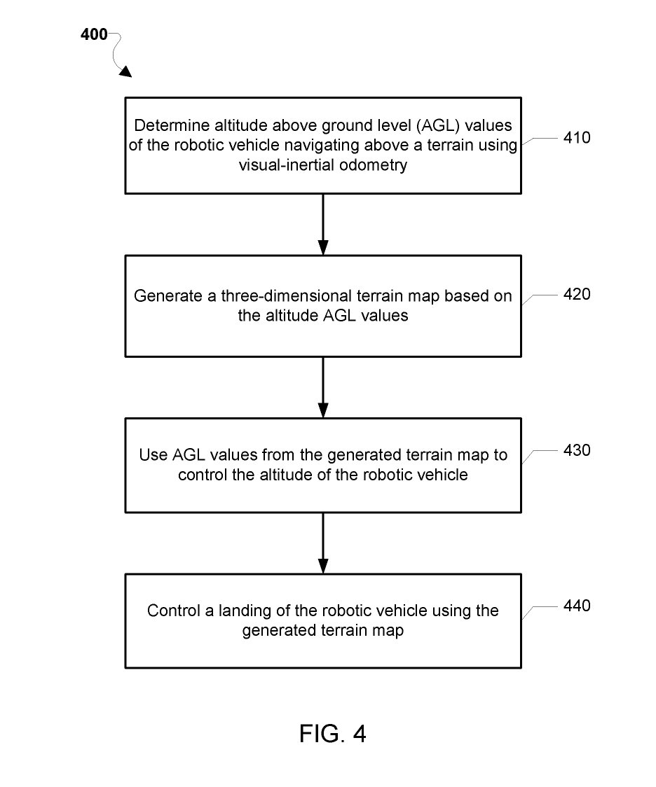

FIG. 4 illustrates a method 400 of controlling an aerial robotic vehicle to land using AGL values obtained from three-dimensional terrain maps generated using visual-inertial odometry according to some embodiments. With reference to FIGS. 1A-4, operations of the method 400 may be performed by a processor (e.g., 260) of a control unit (e.g., 200) of an aerial robotic vehicle (e.g., 100) or another processor (e.g., a processor 314 of a processing device 310). For ease of reference, the term “processor” is used to refer to the processor or processors implementing operations of the method 400.

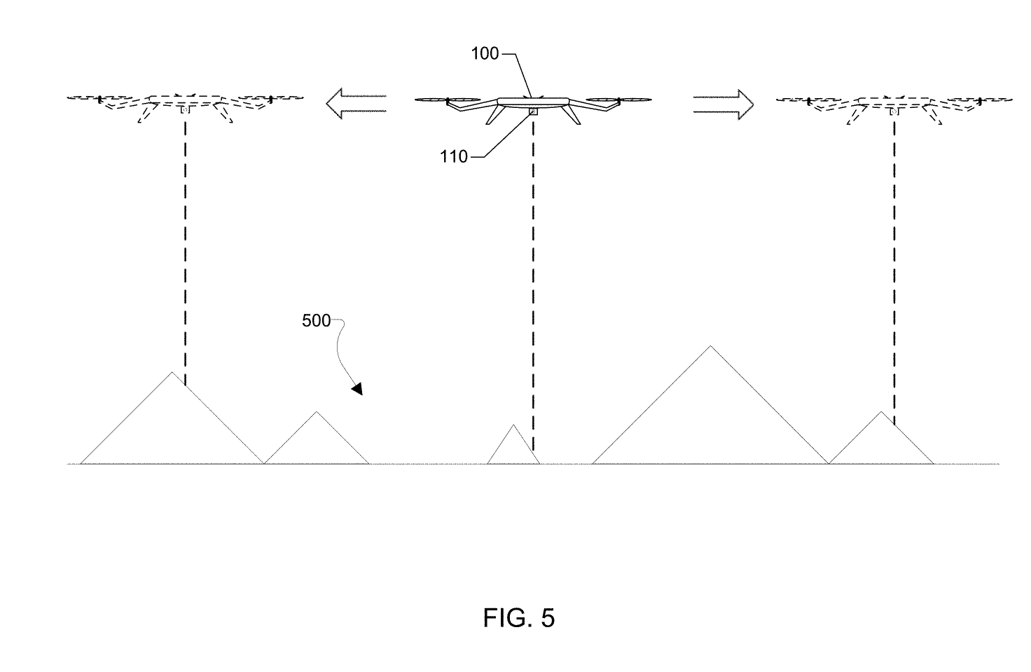

In block 410, the processor (e.g., 260 and/or 314) may determine AGL values of the aerial robotic vehicle navigating above a terrain using visual-inertial odometry. For example, in some embodiments as shown in FIG. 5, an aerial robotic vehicle 100 may fly over a given terrain 500 and capture images of the terrain using a downward-facing camera (e.g., 110). In some embodiments, the aerial robotic vehicle 100 may fly in a circular, spiral or other navigational pattern in order to capture images of the terrain from different perspectives. From the captured images, the processor may generate visual information associated with surface features of the terrain that are identified and tracked across multiple images (e.g., hilltops, building tops, etc.). For example, in some embodiments, the visual information may be generated by determining a relative displacement of a surface feature point (in pixels) from one image to a next image (sometimes referred to as the “pixel disparity”). While the camera 110 captures images of the terrain, an inertial measurement unit (IMU) sensor (e.g., 265) may concurrently monitor and track inertial data of the aerial robotic vehicle 100 flying above the terrain. The inertial data (e.g., angular velocity, acceleration, etc.) may provide information regarding the distances traveled by the camera between images. Using any known visual-inertial odometry technique, the processor may fuse (or combine) the visual information generated from the tracked surface features of the terrain with the concurrent inertial data to generate the altitude AGL values. The altitude AGL values may provide a measurement or estimate of the distance from the camera to the tracked surface features of the terrain.

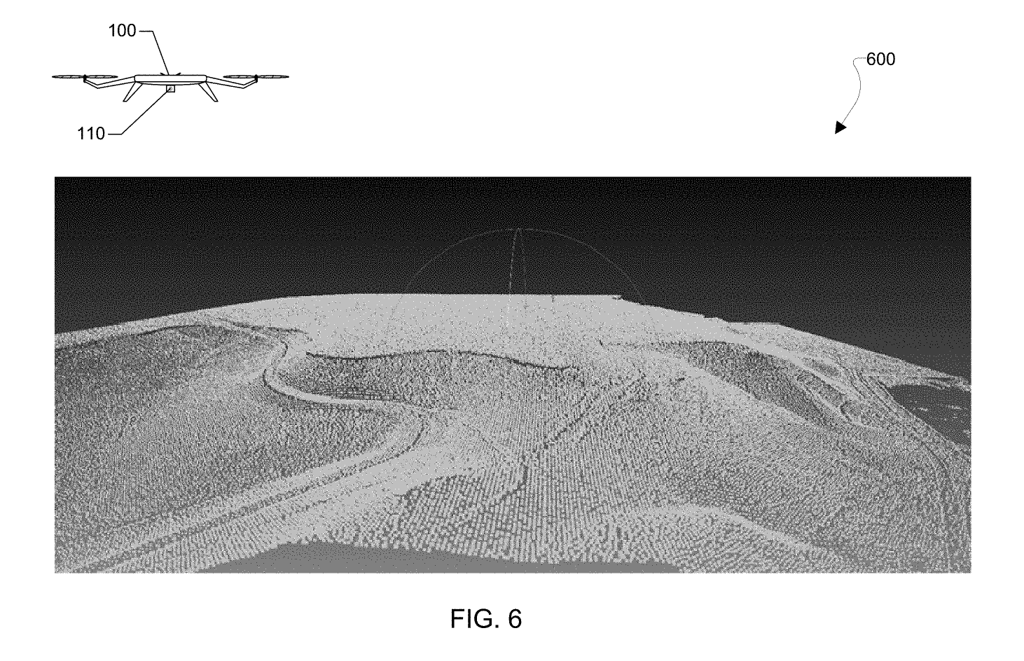

In block 420, the processor may generate a 3-D terrain map based on the altitude AGL values. An example of a topological 3-D terrain map based on altitude AGL values generated using visual-inertial odometry according to some embodiments is illustrated in FIG. 6. In some embodiments, the 3-D terrain map 600 may be generated by assigning the altitude AGL values determined in block 410 to corresponding locations in the map, thereby modeling the terrain as a distribution of altitude AGL values corresponding to various surface feature points of the terrain. When the aerial robotic vehicle 100 is relatively high above the terrain, the collection of altitude AGL values determined in block 410 may represent a sparse distribution of surface feature points. Thus, in some embodiments, points between the surface feature points having an assigned altitude AGL value may be determined through interpolation. As the aerial robotic vehicle 100 approaches the terrain, the resolution of surface features in the captured images may become finer (i.e., less coarse), resulting in a denser distribution of surface feature points. In some embodiments, the terrain map may be correlated to a GPS or other addressable location, such that the map may be stored in the aerial robotic vehicle's memory or other remote storage device for persistent storage, thereby enabling future use by the aerial robotic vehicle 100 or other vehicles in that area.

In block 430, the processor may use AGL values obtained from the generated terrain map control the altitude of the aerial robotic vehicle during various phases of flight, such as takeoff, transit, operating near the ground (e.g., to photograph structures or surface features), and landing. For example, during operations requiring the aerial robotic vehicle to fly at low altitudes (e.g., below 400 feet) at which variations in surface elevation (e.g., hills, valleys, trees, buildings, etc.) present to potential for collision, the processor may use AGL values obtained from the generated terrain map to determine above ground altitudes that the aerial robotic vehicle will need to achieve along the path so that altitude changes (i.e., climbing and descending maneuvers) may be determined and executed before the obstacles are reached or even observable to a collision avoidance camera. For example, an aerial robotic vehicle following terrain (e.g., to photograph or otherwise survey the ground) may not be able to image a tall obstacle hidden behind a rise or a building while flying below at an altitude that is below the crest of a hill or top of the building. In this example, the processor may use AGL values obtained from the generated terrain map to determine that the vehicle will need to continue to climb to an altitude that will allow it to clear the hidden obstacle, and execute the maneuver accordingly, before the obstacle is observed by a camera and/or radar of a collision avoidance system.

In particularly useful applications of various embodiments, the processor may control a landing of the aerial robotic vehicle using AGL values obtained from the generated terrain map in block 440. In some embodiments, the processor may use the terrain map to select a landing area on the terrain, such as a location having surface features that are suitable for landing the aerial robotic vehicle. In some embodiments, the processor may use AGL values obtained from the terrain map to control a trajectory for landing the aerial robotic vehicle based on a surface feature of the selected landing area. In some embodiments, the processor may use AGL values obtained from the terrain map to control the speed of the aerial robotic vehicle to facilitate a soft or controlled landing of the aerial robotic vehicle.

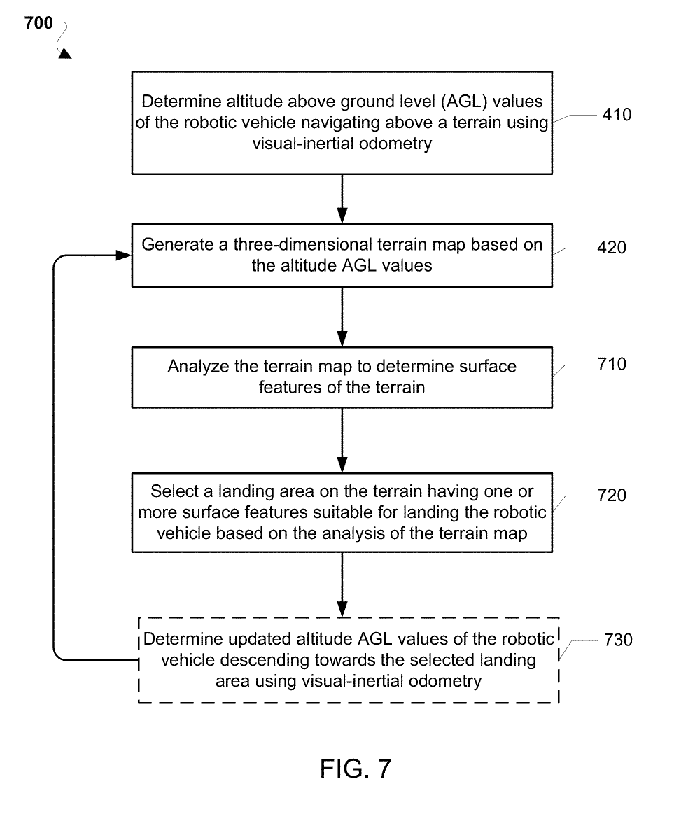

FIG. 7 illustrates a method 700 of selecting a landing area on the terrain using 3-D terrain maps generated using visual-inertial odometry according to some embodiments. With reference to FIGS. 1A-7, operations of the method 700 may be performed by a processor (e.g., 260) of a control unit (e.g., 200) of an aerial robotic vehicle (e.g., 100) or another processor (e.g., a processor 314 of a processing device 310). For ease of reference, the term “processor” is used to refer to the processor or processors implementing operations of the method 700.

In blocks 410 and 420, the processor (e.g., 260, 310) may perform operations of like numbered blocks of the method 400 as described to generate a three-dimensional terrain map based upon determined altitude AGL values.

In block 710, the processor (e.g., 260, 314) may analyze the terrain map to determine surface features of the terrain, such as to identify surface features suitable for potential landing areas. For example, in some embodiments, the processor may analyze the terrain map to identify areas of the terrain map having planar surfaces (e.g., paved surfaces) and areas having curved or other contoured surfaces (e.g., hill tops). The processor may analyze the terrain map to identify areas having sloped surfaces (e.g., inclines, declines) and areas that are relatively flat. In some embodiments, the processor may analyze the terrain map to estimate the sizes of potential landing areas. In some embodiments, the processor may determine the texture of the candidate landing areas. For example, at some altitudes, the resolution of the captured images may be sufficient to enable the processor to identify areas of the terrain that are rocky or smooth and/or the particular type of surface. For example, in some embodiments, by continually or periodically updating the terrain map as the aerial robotic vehicle flies closer to the ground, the processor may detect surface movements indicative of bodies of water and/or high grassy areas. In some embodiments, the processor may perform supplemental image processing and/or cross-reference to other sources of information to aid selecting landing areas or confirm surface feature information extracted from the analysis of the terrain map.

In block 720, the processor may select a landing area on the terrain having one or more surface features suitable for landing the aerial robotic vehicle based on the analysis of the terrain map. For example, in some embodiments, the processor may assign a rating or numerical score to different areas of the terrain based on their respective surface features determined in block 710 and select an area having the best score to serve as the landing area. For example, an area of the terrain having planar and relatively flat surface features may be assigned a higher rating or score than areas having curved and/or steep surfaces. In some embodiments, the processor may select a landing area that additionally or alternatively meets a predetermined set of surface feature criteria. For example, large robotic vehicles may require that the selected landing area be of sufficient size to accommodates the vehicle's footprint plus margin and sufficient area to accommodate drift as may be caused by winds near the ground.

In some embodiments, the processor may use deep learning classification techniques to identify appropriate landing areas within the three-dimensional terrain map as part of the operations in block 720. For example, the processor may use deep learning classification techniques to classify segments of the terrain map based upon different classifications or categories, including open and relatively flat surfaces that may be classified as potential landing areas. Having classified and identified potential landing areas within the three-dimensional terrain map, the processor may then rate or score the identified potential landing areas and select one or a few landing areas based upon ratings or scores.

In block 730, the processor may determine updated altitude AGL values of the aerial robotic vehicle as the vehicle descends towards the selected landing area using visual-inertial odometry. For example, in some embodiments, the processor may continuously or periodically track inertial data and visual information on the surface features of the terrain to update the generated three-dimensional terrain maps and refine altitude AGL values as described in the method 400. Thus, the processor may update the terrain map as the aerial robotic vehicle (e.g., 100) descends towards the selected landing area in order to confirm that the selected landing area is suitable for the landing. For example, as the aerial robotic vehicle 100 approaches the landing area, the resolution of the surface features of the terrain may become finer (i.e., less coarse). As a result, the updated altitude AGL values of the surface features, and thus the updated terrain map may become denser, resulting in the more detailed representations of the surface features of the selected landing area in the terrain map (e.g., 600).

In some embodiments, after determining the updated altitude AGL values in block 730, the processor may repeat the operations of blocks 420, 710, and 720 based on the updated altitude AGL values. For example, in some embodiments, the processor may select a new landing area or refine the landing area selection in block 720 based on the updated terrain map.

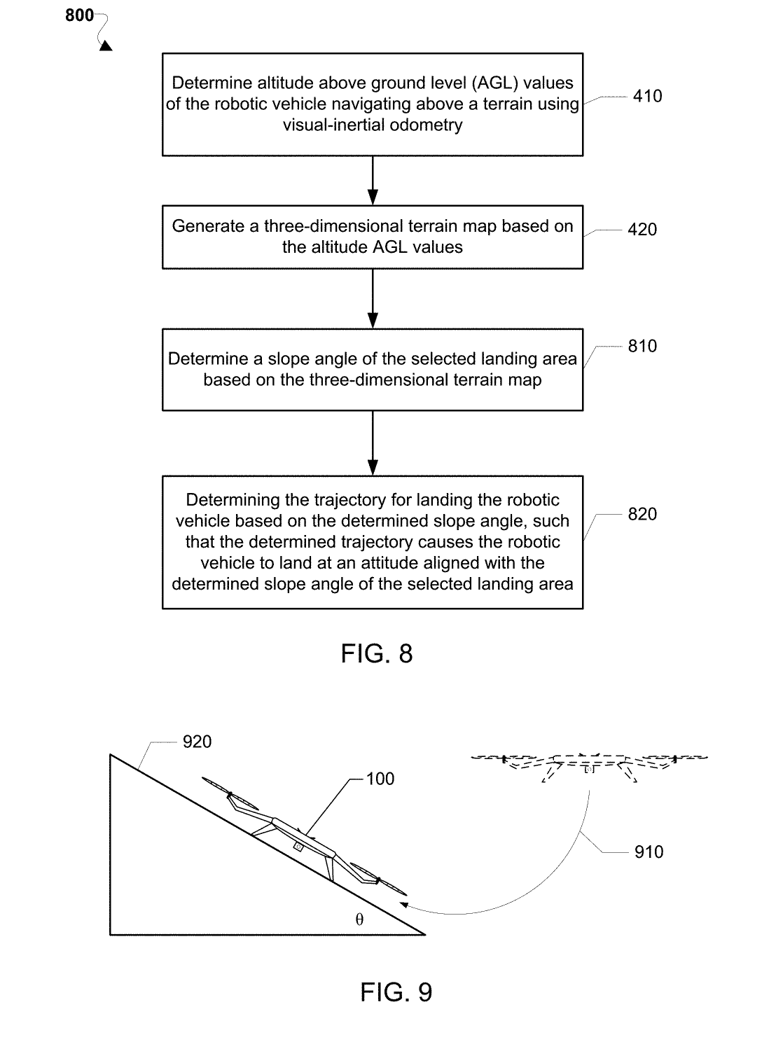

FIG. 8 illustrates a method 800 of controlling a landing trajectory of the aerial robotic vehicle using altitude AGL values obtained from a 3-D terrain map generated using visual-inertial odometry according to some embodiments. With reference to FIGS. 1A-8, operations of the method 800 may be performed by a processor (e.g., 260) of a control unit (e.g., 200) of an aerial robotic vehicle (e.g., 100) or another processor (e.g., a processor 314 of a processing device 310). For ease of reference, the term “processor” is used to refer to the processor or processors implementing operations of the method 800.

In blocks 410 and 420, the processor (e.g., 260, 314) may perform operations of like numbered blocks of the method 400 as described.

In block 810, the processor may determine a slope angle of the selected landing area. For example, in some embodiments, when the selected landing area has a sloped surface feature (i.e., incline or decline), the processor may determine an angle of the sloped surface by fitting a geometrical plane to three or more surface feature points selected from the terrain map corresponding to the selected landing area. In some embodiments, the surface feature points selected to represent the slope of the landing area may be actual altitude AGL measurements. In some embodiments, the surface feature points used to represent the slope of the landing area may be determined based on averages or other statistical representations corresponding to multiple altitude AGL measurements of the selected landing area. Once a geometric plane is fit to the three or more surface feature points, the processor may determine the slope angle by calculating an angular offset of the fitted plane relative to a real-world or other predetermined 3-D coordinate system associated with the terrain map.

In block 820, the processor may determine a trajectory for landing the aerial robotic vehicle based on the determined slope angle. In some embodiments, the determined trajectory may cause the aerial robotic vehicle to land at an attitude aligned with the determined slope angle of the selected landing area. For example, as shown in FIG. 9, in some embodiments, the processor may determine a landing trajectory 910 that enables the aerial robotic vehicle 100 to land on the sloped surface 920 of the selected landing area with the aerial robotic vehicle's attitude (or orientation) aligned in parallel to the slope angle determined in block 810 in one or more dimensions (e.g., 0). By controlling a landing trajectory (e.g., 910) of an aerial robotic vehicle to account for the slope angle of the selected landing area, aggressive landings or collisions with the sloped surface of the landing area the aerial robotic vehicle due to axis misalignments between the vehicle and sloped surface may be avoided.

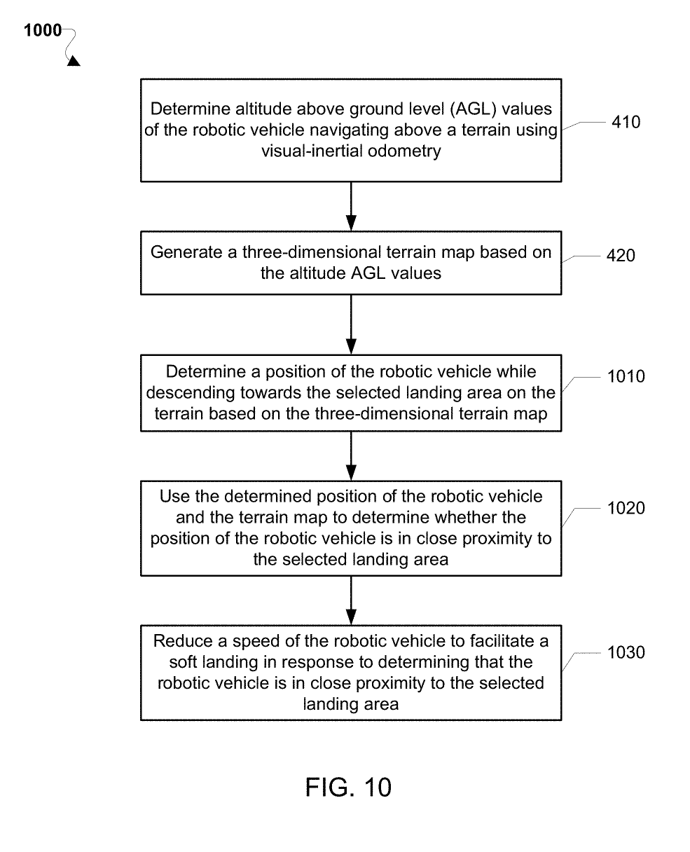

FIG. 10 illustrates a method 1000 of controlling the speed of the aerial robotic vehicle to facilitate a soft or controlled landing of the aerial robotic vehicle using 3-D terrain maps generated using visual-inertial odometry according to some embodiments. With reference to FIGS. 1A-10, operations of the method 1000 may be performed by a processor (e.g., 260) of a control unit (e.g., 200) of an aerial robotic vehicle (e.g., 100) or another processor (e.g., a processor 314 of a processing device 310). For ease of reference, the term “processor” is used to refer to the processor or processors implementing operations of the method 1000.

In blocks 410 and 420, the processor (e.g., 260, 314) may perform operations of like numbered blocks of the method 400 as described.

In block 1010, the processor may determine a position of the aerial robotic vehicle (e.g., 100) while descending towards the selected landing area on the terrain. In some embodiments, the position of the aerial robotic vehicle (i.e., altitude and location) may be determined using any known technique. For example, in some embodiments, the processor may determine the altitude and location of the vehicle using a known visual-inertial odometry technique based on the outputs of a forward-facing camera and an inertial measurement unit (IMU) sensor. In some embodiments, the processor may determine the altitude and location of the vehicle based on the outputs of other sensors, such as a GPS sensor.

In block 1020, the processor may use the determined position of the aerial robotic vehicle and the terrain map to determine whether the position of the aerial robotic vehicle is in close proximity to the selected landing area. For example, in some embodiments, the processor may determine the distance to and the AGL value of the aerial robotic vehicle (e.g., 100) above the selected landing surface as indicated in the 3-D terrain map. In some embodiments, the processor may determine the distance to the selected landing surface in the form of an absolute distance vector. In some embodiments, the processor may determine the distance to the selected landing surface in the form of a relative distance vector. In some embodiments, the processor may determine whether the position of the aerial robotic vehicle is in close proximity to the selected landing area based on whether the determined distance (vector) is less than a predetermined threshold distance (vector).

In block 1030, the processor may reduce the speed of the aerial robotic vehicle (e.g. 100) as the vehicle approaches the selected landing area to facilitate a soft landing. For example, the processor may reduce the speed of the aerial robotic vehicle in response to determining that the aerial robotic vehicle is in close proximity to the selected landing area. In some embodiments, the processor may control the speed and/or direction of the rotors to reduce the speed of the aerial robotic vehicle 100 as it approaches the selected landing area. In some embodiments, the processor may continue to determine the distance between the aerial robotic vehicle and the selected landing area and adjust the speed of the aerial robotic vehicle accordingly as the aerial robotic vehicle approaches the selected landing area.

The various embodiments illustrated and described are provided merely as examples to illustrate various features of the claims. However, features shown and described with respect to any given embodiment are not necessarily limited to the associated embodiment and may be used or combined with other embodiments that are shown and described. In particular, various embodiments are not limited to use on aerial UAVs and may be implemented on any form of robotic vehicle. Further, the claims are not intended to be limited by any one example embodiment. For example, one or more of the operations of the methods 600, 700, 800, and 1000 may be substituted for or combined with one or more operations of the methods 600, 700, 800, 1000 and vice versa.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, two or more microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of controlling an aerial robotic vehicle by a processor of the aerial robotic vehicle, comprising;
determining a plurality of altitude above ground level values of the aerial robotic vehicle navigating above a terrain using visual-inertial odometry;
generating a terrain map based on the plurality of altitude above ground level values; and
using the generated terrain map to control altitude of the aerial robotic vehicle.

2. The method of claim 1, wherein using the generated terrain map to control altitude of the aerial robotic vehicle comprises using the generated terrain map to control a landing of the aerial robotic vehicle.

3. The method of claim 2, wherein using the generated terrain map to control the landing of the aerial robotic vehicle comprises:
analyzing the terrain map to determine surface features of the terrain; and
selecting a landing area on the terrain having one or more surface features suitable for landing the aerial robotic vehicle based on the analysis of the terrain map.

4. The method of claim 3, wherein the one or more surface features suitable for landing the aerial robotic vehicle comprise a desired surface type, size, texture, incline, contour, accessibility, or any combination thereof.

5. The method of claim 3, wherein selecting a landing area on the terrain further comprises:
using deep learning classification techniques by the processor to classify surface features within the generated terrain map; and
selecting the landing area from among surface features classified as potential landing areas.

6. The method of claim 3, wherein using the generated terrain map to control the landing of the aerial robotic vehicle further comprises:
determining a trajectory for landing the aerial robotic vehicle based on a surface feature of the selected landing area.

7. The method of claim 6, wherein the surface feature of the selected landing area is a slope and wherein determining the trajectory for landing the aerial robotic vehicle based on the surface feature of the selected landing area comprises:
determining a slope angle of the selected landing area; and
determining the trajectory for landing the aerial robotic vehicle based on the determined slope angle.

8. The method of claim 2, wherein using the generated terrain map to control the landing of the aerial robotic vehicle comprises:
determining a position of the aerial robotic vehicle while descending towards a landing area;
using the determined position of the aerial robotic vehicle and the terrain map to determine whether the aerial robotic vehicle is in close proximity to the landing area; and
reducing a speed of the aerial robotic vehicle to facilitate a soft landing in response to determining that the aerial robotic vehicle is in close proximity to the landing area.

9. The method of claim 2, wherein using the generated terrain map to control the landing of the aerial robotic vehicle comprises:
determining a plurality of updated altitude above ground level values using visual-inertial odometry as the aerial robotic vehicle descends towards a landing area;
updating the terrain map based on the plurality of updated altitude above ground level values; and
using the updated terrain map to control the landing of the aerial robotic vehicle.

10. The method of claim 1, wherein the aerial robotic vehicle is an autonomous aerial robotic vehicle.

11. An aerial robotic vehicle, comprising;
a processor configured with processor-executable instructions to:
determine a plurality of altitude above ground level values of the aerial robotic vehicle navigating above a terrain using visual-inertial odometry;
generate a terrain map based on the plurality of altitude above ground level values; and
use the generated terrain map to control altitude of the aerial robotic vehicle.

12. The aerial robotic vehicle of claim 11, wherein the processor is further configured with processor-executable instructions to use the generated terrain map to control a landing of the aerial robotic vehicle.

13. The aerial robotic vehicle of claim 11, wherein the processor is further configured with processor-executable instructions to:
analyze the terrain map to determine surface features of the terrain;
select a landing area on the terrain having one or more surface features suitable for landing the aerial robotic vehicle based on the analysis of the terrain map; and
use the generated terrain map to control the landing of the aerial robotic vehicle.

14. The aerial robotic vehicle of claim 13, wherein the one or more surface features suitable for landing the aerial robotic vehicle comprise a desired surface type, size, texture, incline, contour, accessibility, or any combination thereof.

15. The aerial robotic vehicle of claim 13, wherein the processor is further configured with processor-executable instructions to select a landing area on the terrain further by:
using deep learning classification techniques by the processor to classify surface features within the generated terrain map; and
selecting the landing area from among surface features classified as potential landing areas.

16. The aerial robotic vehicle of claim 13, wherein the processor is further configured with processor-executable instructions to:
determine a trajectory for landing the aerial robotic vehicle based on a surface feature of the selected landing area.

17. The aerial robotic vehicle of claim 16,
wherein the surface feature of the selected landing area is a slope, and
wherein the processor is further configured with processor-executable instructions to determine the trajectory for landing the aerial robotic vehicle based on the surface feature of the selected landing area by:
determining a slope angle of the selected landing area; and
determining the trajectory for landing the aerial robotic vehicle based on the determined slope angle.

18. The aerial robotic vehicle of claim 11, wherein the processor is further configured with processor-executable instructions to:
determine a position of the aerial robotic vehicle while descending towards a landing area;
use the determined position of the aerial robotic vehicle and the terrain map to determine whether the aerial robotic vehicle is in close proximity to the landing area; and
reduce a speed of the aerial robotic vehicle to facilitate a soft landing in response to determining that the aerial robotic vehicle is in close proximity to the landing area.

19. The aerial robotic vehicle of claim 11, wherein the processor is further configured with processor-executable instructions to:
determine a plurality of updated altitude above ground level values using visual-inertial odometry as the aerial robotic vehicle descends towards a landing area;
update the terrain map based on the plurality of updated altitude above ground level values; and
use the updated terrain map to control the landing of the aerial robotic vehicle.

20. The aerial robotic vehicle of claim 11, wherein the processor is further configured with processor-executable instructions to operate autonomously.

21. A processing device configured for use in an aerial robotic vehicle, and configured to:
determine a plurality of altitude above ground level values of the aerial robotic vehicle navigating above a terrain using visual-inertial odometry;
generate a terrain map based on the plurality of altitude above ground level values; and
use the generated terrain map to control altitude of the aerial robotic vehicle.

22. The processing device of claim 21, wherein the processing device is further configured to use the generated terrain map to control a landing of the aerial robotic vehicle.

23. The processing device of claim 22, wherein the processing device is further configured with processor-executable instructions to:
analyze the terrain map to determine surface features of the terrain;
select a landing area on the terrain having one or more surface features suitable for landing the aerial robotic vehicle based on the analysis of the terrain map; and
use the generated terrain map to control the landing of the aerial robotic vehicle.

24. The processing device of claim 23, wherein the one or more surface features suitable for landing the aerial robotic vehicle comprise a desired surface type, size, texture, incline, contour, accessibility, or any combination thereof.

25. The processing device of claim 23, wherein the processing device is further configured to select a landing area on the terrain further by:
using deep learning classification techniques to classify surface features within the generated terrain map; and
selecting the landing area from among surface features classified as potential landing areas.

26. The processing device of claim 23, wherein the processing device is further configured to:
determine a trajectory for landing the aerial robotic vehicle based on a surface feature of the selected landing area.

27. The processing device of claim 26,
wherein the surface feature of the selected landing area is a slope, and
wherein the processing device is further configured to determine the trajectory for landing the aerial robotic vehicle based on the surface feature of the selected landing area by:
determining a slope angle of the selected landing area; and
determining the trajectory for landing the aerial robotic vehicle based on the determined slope angle.

28. The processing device of claim 21, wherein the processing device is further configured to:
determine a position of the aerial robotic vehicle while descending towards a landing area;
use the determined position of the aerial robotic vehicle and the terrain map to determine whether the aerial robotic vehicle is in close proximity to the landing area; and
reduce a speed of the aerial robotic vehicle to facilitate a soft landing in response to determining that the aerial robotic vehicle is in close proximity to the landing area.

29. The processing device of claim 21, wherein the processing device is further configured to:
determine a plurality of updated altitude above ground level values using visual-inertial odometry as the aerial robotic vehicle descends towards a landing area;
update the terrain map based on the plurality of updated altitude above ground level values; and
use the updated terrain map to control the landing of the aerial robotic vehicle.

30. An aerial robotic vehicle, comprising;
means for determining a plurality of altitude above ground level values of the aerial robotic vehicle navigating above a terrain using visual-inertial odometry;
means for generating a terrain map based on the plurality of altitude above ground level values; and
means for using the generated terrain map to control altitude of the aerial robotic vehicle.
